(19) United States
(12) Patent Application Publication
(10) Pub. No.: US 2020/0070777 A1
(43) Pub. Date: Mar. 5, 2020

(54) SYSTEMS AND METHODS FOR A DIGITAL KEY

(71) Applicant: NIO USA, Inc., San Jose, CA (US)

(72) Inventors: Fang Chen, Sunnyvale, CA (US); Jonathan A. Cox, San Jose, CA (US); Bhaskar Saha, Saratoga, CA (US); Xiaochen Jia, Sunnyvale, CA (US); Karthick Kumar Malli Raghavan, San Jose, CA (US); Infantdani Abel Rayan, Santa Clara, CA (US); Christopher F. Pouliot, San Mateo, CA (US); Nilesh V. Kulkarni, Saratoga, CA (US)

(21) Appl. No.: 16/117,936

(22) Filed: Aug. 30, 2018

(51) Int. Cl. B60R 25/24; E05B 81/64; B60R 25/20; G06F 3/01

(52) U.S. Cl. CPC B60R 25/241; G06F 3/017; B60R 25/2045; E05B 81/64

(57) ABSTRACT

Systems of an electrical vehicle and the operations thereof are provided. A method for controlling access to a vehicle includes a processor of a vehicle control system determining a signal strength for sensors of a vehicle. The processor determines a location of a user device based on the determined signal strength for the sensors. The processor enables a gesture recognition system based on the determination of the location of the user device. The processor receives data from the user device, determines a type of gesture associated with the received data from the user device, and activates one or more functions of the vehicle based on the determined type of gesture.

### FIELD

The present disclosure is generally directed to vehicle systems, in particular, toward enabling access to vehicle systems.

### BACKGROUND

In recent years, transportation methods have changed substantially. This change is due in part to a concern over the limited availability of natural resources, a proliferation in personal technology, and a societal shift to adopt more environmentally friendly transportation solutions. These considerations have encouraged the development of a number of new flexible-fuel vehicles, hybrid-electric vehicles, and electric vehicles.

While these vehicles appear to be new they are generally implemented as a number of traditional subsystems that are merely tied to an alternative power source. In fact, the design and construction of the vehicles is limited to standard frame sizes, shapes, materials, and transportation concepts. Among other things, these limitations fail to take advantage of the benefits of new technology, power sources, and support infrastructure.

Traditionally, access to vehicle systems is typically granted on a basis of a key. For example, a single key may unlock doors, provide access to electrical systems, and start the vehicle. These traditional systems require users of the vehicle to be in possession of a key. Such systems are inefficient in a number of ways. For example, allowing another user to use the vehicle requires the transfer of the key. What is needed is a vehicle access solution reducing the requirement of a physical key while enabling multiple authorized users to obtain access to a vehicle.

### BRIEF DESCRIPTION OF THE DRAWINGS

FIG. 1 shows a vehicle in accordance with embodiments of the present disclosure;

FIG. 2A shows a plan view of the vehicle in accordance with at least some embodiments of the present disclosure;

FIG. 2B shows a plan view of the vehicle in accordance with at least some embodiments of the present disclosure;

FIG. 3 is a block diagram of an embodiment of a communication environment of the vehicle in accordance with embodiments of the present disclosure;

FIG. 4 shows an embodiment of the instrument panel of the vehicle according to one embodiment of the present disclosure;

FIG. 5 is a block diagram of an embodiment of a communications subsystem of the vehicle;

FIG. 6 is a block diagram of a computing environment associated with the embodiments presented herein;

FIG. 7 is a block diagram of a computing device associated with one or more components described herein;

FIG. 8 shows a plan view of the vehicle in accordance with at least some embodiments of the present disclosure;

FIG. 9A shows a plan view of a user device in accordance with at least some embodiments of the present disclosure;

FIG. 9B illustrates sensor data in accordance with at least some embodiments of the present disclosure;

FIG. 9C shows a plan view of a convolutional neural network in accordance with at least some embodiments of the present disclosure;

FIG. 10 is a flowchart of a method in accordance with at least some embodiments of the present disclosure; and

FIG. 11 is a flowchart of a method in accordance with at least some embodiments of the present disclosure;

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

Because of the shortcomings with contemporary key-systems for vehicles, what is needed is a system enabling greater convenience. For example, reducing a need for car users to carry extra gadgets. As described below, a smart system capable of understanding user intentions and properly responding is described.

The digital key systems describe below generally comprise two main components, proximity detection and gesture recognition. The proximity detection detects the distance between the car and the car user as well as the orientation of the car user relative to the car. When the distance is close enough (for example compared to a predetermined threshold), gesture recognition can be used to access the car.

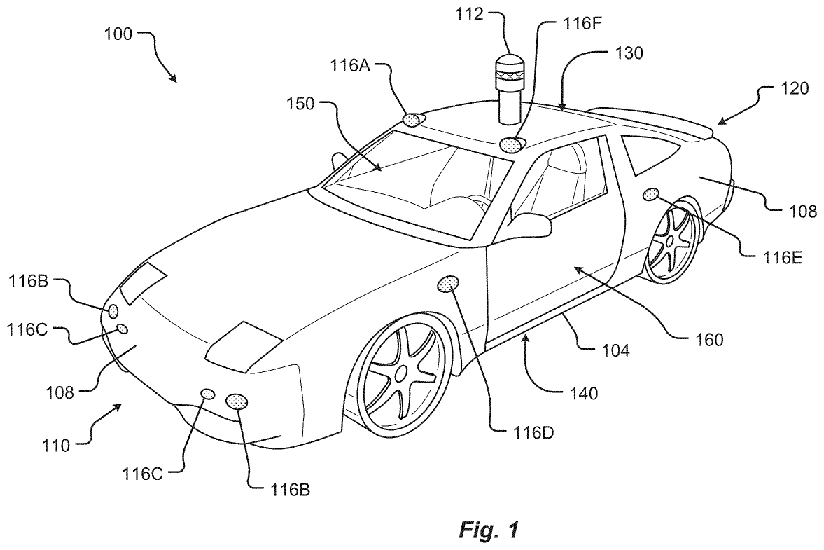

FIG. 1 shows a perspective view of a vehicle 100 in accordance with embodiments of the present disclosure. The electric vehicle 100 comprises a vehicle front 110, vehicle aft or rear 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

In some embodiments, the vehicle 100 may include a number of sensors, devices, and/or systems that are capable of assisting in driving operations. Examples of the various sensors and systems may include, but are in no way limited to, one or more of cameras (e.g., independent, stereo, combined image, etc.), infrared (IR) sensors, radio frequency (RF) sensors, ultrasonic sensors (e.g., transducers, transceivers, etc.), RADAR sensors (e.g., object-detection sensors and/or systems), LIDAR systems, odometry sensors and/or devices (e.g., encoders, etc.), orientation sensors (e.g., accelerometers, gyroscopes, magnetometer, etc.), navigation sensors and systems (e.g., GPS, etc.), and other ranging, imaging, and/or object-detecting sensors. The sensors may be disposed in an interior space 150 of the vehicle 100 and/or on an outside of the vehicle 100. In some embodiments, the sensors and systems may be disposed in one or more portions of a vehicle 100 (e.g., the frame 104, a body panel, a compartment, etc.).

The vehicle 100 may comprise a number of Bluetooth low energy (BLE) emitting sensors. Such BLE sensors may be programmed to emit signals at a certain frequency with variable intensity. The intensity may determine the range of the emitted signals. The vehicle 100 may have several combinations of low range-high frequency/high range-low frequency sensors placed on vehicle's surroundings. A user device may execute an application capable of listening to signals emitted from the sensors.

In some embodiments, the vehicle 100 may be equipped with high-frequency BLE emitting sensors and low-frequency BLE emitting sensors. High-frequency BLE emitting sensors may be used to communicate with devices within a particular distance from the vehicle 100. Low-frequency BLE emitting sensors may be used to communicate with devices outside a particular distance from the vehicle. In some embodiments, a control system of the vehicle 100 may determine an estimated distance of a user device from the vehicle 100 prior to determining which of the high-frequency BLE emitting sensors and the low-frequency BLE emitting sensors to use to communicate with the device. In some embodiments, BLE emitting sensors may be capable of communicating over one or both of high-frequencies and low-frequencies. In such an embodiment, control system of the vehicle 100 may determine an estimated distance of a user device from the vehicle 100 prior to determining whether to communicate with the device over high-frequency or low-frequency. The BLE emitting sensors may be, for example, of an iBeacon protocol

The variable intensity and frequency of the BLE emitting sensors may be used to communicate with moving devices. For example, when a user approaches or moves away from the vehicle, signals from each sensor of the vehicle may be received by the user device with varying intensities. As the user approaches the vehicle, the user device receives stronger intensity signals from different sensors placed on the vehicle. Depending on the signal intensity, as the user approaches the user is localized to the appropriate door taking signal strength indicators from various sensors all over the vehicle. The signal strength indicators may be used to localize where the user is in relation to the vehicle using algorithms such as triangulation calculations.

In the case of a user moving away from the car, the strength of the signals from each sensor of the vehicle may decrease as the user walks away from the car. Using the varying intensity of the signals of the sensors of the vehicle as received by the user device, localization of user may be performed using the same algorithm as above.

In some embodiments, the device may attempt to handshake with the vehicle as soon as the device first receives signals from the vehicle sensors. The vehicle may pose a challenge and an authentication/identification process could be performed prior to the device performing any analysis from the received signals.

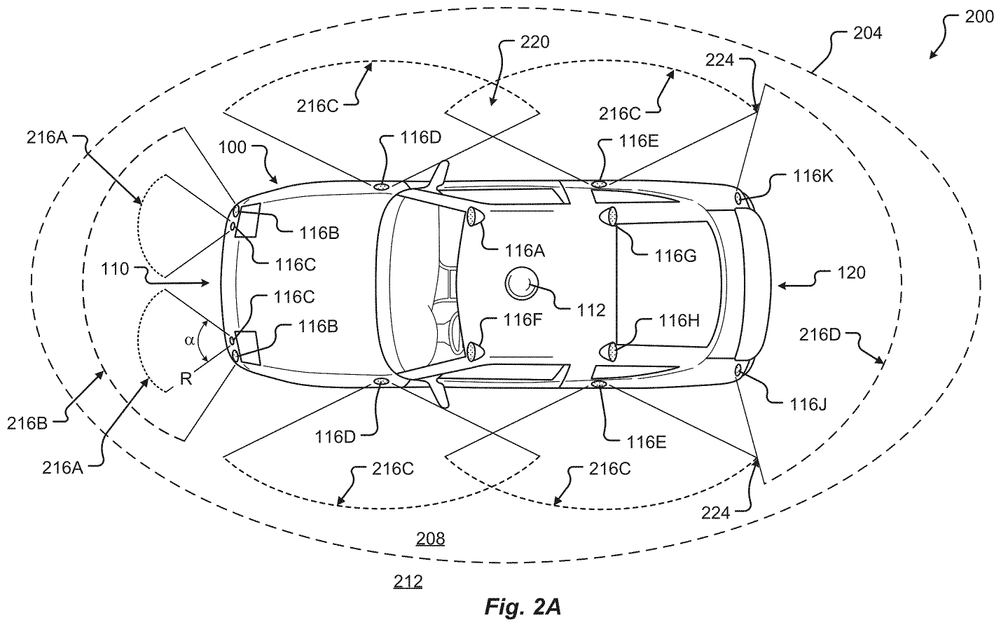

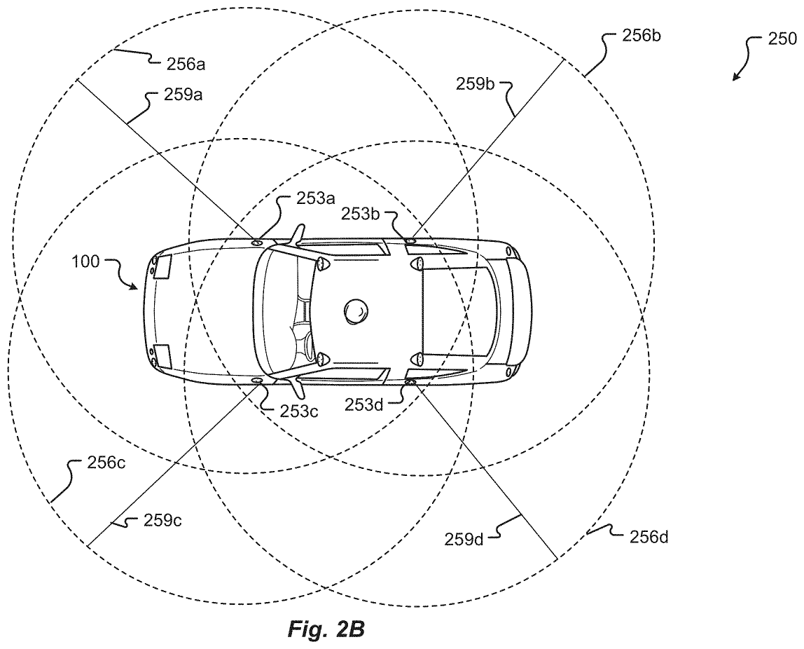

As shown in FIG. 1, the vehicle 100 may, for example, include at least one of a ranging and imaging system 112 (e.g., LIDAR, etc.), an imaging sensor 116A, 116F (e.g., camera, IR, etc.), a radio object-detection and ranging system sensors 116B (e.g., RADAR, RF, etc.), ultrasonic sensors 116C, and/or other object-detection sensors 116D, 116E. In some embodiments, the LIDAR system 112 and/or sensors may be mounted on a roof 130 of the vehicle 100. In one embodiment, the RADAR sensors 116B may be disposed at least at a front 110, aft 120, or side 160 of the vehicle 100. Among other things, the RADAR sensors may be used to monitor and/or detect a position of other vehicles, pedestrians, and/or other objects near, or proximal to, the vehicle 100. While shown associated with one or more areas of a vehicle 100, it should be appreciated that any of the sensors and systems 116A-K, 112 illustrated in FIGS. 1 and 2 may be disposed in, on, and/or about the vehicle 100 in any position, area, and/or zone of the vehicle 100.

Referring now to FIG. 2A, a plan view of a vehicle 100 will be described in accordance with embodiments of the present disclosure. In particular, FIG. 2A shows a vehicle sensing environment 200 at least partially defined by the sensors and systems 116A-K, 112 disposed in, on, and/or about the vehicle 100. Each sensor 116A-K may include an operational detection range R and operational detection angle α. The operational detection range R may define the effective detection limit, or distance, of the sensor 116A-K. In some cases, this effective detection limit may be defined as a distance from a portion of the sensor 116A-K (e.g., a lens, sensing surface, etc.) to a point in space offset from the sensor 116A-K. The effective detection limit may define a distance, beyond which, the sensing capabilities of the sensor 116A-K deteriorate, fail to work, or are unreliable. In some embodiments, the effective detection limit may define a distance, within which, the sensing capabilities of the sensor 116A-K are able to provide accurate and/or reliable detection information. The operational detection angle α may define at least one angle of a span, or between horizontal and/or vertical limits, of a sensor 116A-K. As can be appreciated, the operational detection limit and the operational detection angle α of a sensor 116A-K together may define the effective detection zone 216A-D (e.g., the effective detection area, and/or volume, etc.) of a sensor 116A-K.

In some embodiments, the vehicle 100 may include a ranging and imaging system 112 such as LIDAR, or the like. The ranging and imaging system 112 may be configured to detect visual information in an environment surrounding the vehicle 100. The visual information detected in the environment surrounding the ranging and imaging system 112 may be processed (e.g., via one or more sensor and/or system processors, etc.) to generate a complete 360-degree view of an environment 200 around the vehicle. The ranging and imaging system 112 may be configured to generate changing 360-degree views of the environment 200 in real-time, for instance, as the vehicle 100 drives. In some cases, the ranging and imaging system 112 may have an effective detection limit 204 that is some distance from the center of the vehicle 100 outward over 360 degrees. The effective detection limit 204 of the ranging and imaging system 112 defines a view zone 208 (e.g., an area and/or volume, etc.) surrounding the vehicle 100. Any object falling outside of the view zone 208 is in the undetected zone 212 and would not be detected by the ranging and imaging system 112 of the vehicle 100.

Sensor data and information may be collected by one or more sensors or systems 116A-K, 112 of the vehicle 100 monitoring the vehicle sensing environment 200. This information may be processed (e.g., via a processor, computer-vision system, etc.) to determine targets (e.g., objects, signs, people, markings, roadways, conditions, etc.) inside one or more detection zones 208, 216A-D associated with the vehicle sensing environment 200. In some cases, information from multiple sensors 116A-K may be processed to form composite sensor detection information. For example, a first sensor 116A and a second sensor 116F may correspond to a first camera 116A and a second camera 116F aimed in a forward traveling direction of the vehicle 100. In this example, images collected by the cameras 116A, 116F may be combined to form stereo image information. This composite information may increase the capabilities of a single sensor in the one or more sensors 116A-K by, for example, adding the ability to determine depth associated with targets in the one or more detection zones 208, 216A-D. Similar image data may be collected by rear view cameras (e.g., sensors 116G, 116H) aimed in a rearward traveling direction vehicle 100.

In some embodiments, multiple sensors 116A-K may be effectively joined to increase a sensing zone and provide increased sensing coverage. For instance, multiple RADAR sensors 116B disposed on the front 110 of the vehicle may be joined to provide a zone 216B of coverage that spans across an entirety of the front 110 of the vehicle. In some cases, the multiple RADAR sensors 116B may cover a detection zone 216B that includes one or more other sensor detection zones 216A. These overlapping detection zones may provide redundant sensing, enhanced sensing, and/or provide greater detail in sensing within a particular portion (e.g., zone 216A) of a larger zone (e.g., zone 216B). Additionally or alternatively, the sensors 116A-K of the vehicle 100 may be arranged to create a complete coverage, via one or more sensing zones 208, 216A-D around the vehicle 100. In some areas, the sensing zones 216C of two or more sensors 116D, 116E may intersect at an overlap zone 220. In some areas, the angle and/or detection limit of two or more sensing zones 216C, 216D (e.g., of two or more sensors 116E, 116J, 116K) may meet at a virtual intersection point 224.

The vehicle 100 may include a number of sensors 116E, 116G, 116H, 116J, 116K disposed proximal to the rear 120 of the vehicle 100. These sensors can include, but are in no way limited to, an imaging sensor, camera, IR, a radio object-detection and ranging sensors, RADAR, RF, ultrasonic sensors, and/or other object-detection sensors. Among other things, these sensors 116E, 116G, 116H, 116J, 116K may detect targets near or approaching the rear of the vehicle 100. For example, another vehicle approaching the rear 120 of the vehicle 100 may be detected by one or more of the ranging and imaging system (e.g., LIDAR) 112, rear-view cameras 116G, 116H, and/or rear facing RADAR sensors 116J, 116K. As described above, the images from the rear-view cameras 116G, 116H may be processed to generate a stereo view (e.g., providing depth associated with an object or environment, etc.) for targets visible to both cameras 116G, 116H. As another example, the vehicle 100 may be driving and one or more of the ranging and imaging system 112, front-facing cameras 116A, 116F, front-facing RADAR sensors 116B, and/or ultrasonic sensors 116C may detect targets in front of the vehicle 100. This approach may provide critical sensor information to a vehicle control system in at least one of the autonomous driving levels described above. For instance, when the vehicle 100 is driving autonomously (e.g., Level 3, Level 4, or Level 5) and detects other vehicles stopped in a travel path, the sensor detection information may be sent to the vehicle control system of the vehicle 100 to control a driving operation (e.g., braking, decelerating, etc.) associated with the vehicle 100 (in this example, slowing the vehicle 100 as to avoid colliding with the stopped other vehicles). As yet another example, the vehicle 100 may be operating and one or more of the ranging and imaging system 112, and/or the side-facing sensors 116D, 116E (e.g., RADAR, ultrasonic, camera, combinations thereof, and/or other type of sensor), may detect targets at a side of the vehicle 100. It should be appreciated that the sensors 116A-K may detect a target that is both at a side 160 and a front 110 of the vehicle 100 (e.g., disposed at a diagonal angle to a centerline of the vehicle 100 running from the front 110 of the vehicle 100 to the rear 120 of the vehicle). Additionally or alternatively, the sensors 116A-K may detect a target that is both, or simultaneously, at a side 160 and a rear 120 of the vehicle 100 (e.g., disposed at a diagonal angle to the centerline of the vehicle 100).

As illustrated in the environment 250 of FIG. 2B, the vehicle 100 may comprise a number of sensors 253a-253d. For example, in some embodiments, sensors may be Bluetooth or another RF technology. The sensors 253a-253d may be placed around the body of the vehicle 100, for example, a sensor 253a may be placed on each corner of the vehicle 100, or on each door, or in other locations.

The sensors may each be associated with a range 256a-256d. For example, a single sensor 253a may be capable of transmitting a signal to a user device up to a particular distance 259a away. Each sensor 253a-253d may be associated with a particular distance 259a-259d which sets out the radius of the sensor's 253a-253d range 256a-256d.

The sensors 253a-253d may be capable of communicating with a user device. For example, a user device such as a smartphone may be equipped with a sensor such as a Bluetooth sensor or an antenna. The sensors 253a-253d may be capable of communicating with a sensor of a user device in such a way as to allow the user device to determine a signal strength between each sensor 253a-253d and the antenna or sensor of the user device. In some embodiments, this signal strength determination may be made by the user device, while in other embodiments, the signal strength may be determined by a control system of the vehicle 100.

One or more of the sensors 253a-253d may be capable of receiving data from a user device. For example, a sensor 253a may be capable of receiving raw sensor data from a sensor of a user device such as an accelerometer.

In some embodiments, the control system of the vehicle 100 may be in communication with a cloud-based server. The server and/or the control system of the vehicle 100 may be capable of executing one or more applications independently or in conjunction with each other. For example, the server and/or the control system of the vehicle 100 may be capable of executing a location recognition system, a user recognition system, a gesture recognition system, and/or other systems.

In some embodiments, a user database may be stored in memory onboard the vehicle or on a cloud-based server. A user database may comprise user information relating to a number of different users.

User information for a particular user may comprise information such as one or more user devices associated with the user, one or more gesture recognition models associated with the user, a list of vehicles associated with the user, one or more vehicle permissions associated with the user, and/or other information.

In some embodiments, a cloud-based server may handle processing for a number of tasks. One or more cloud-based servers may be capable of executing algorithms on the fly for vehicles. For example, raw data could be transmitted directly from user device to cloud, or from user device to vehicle to cloud. A server may be capable of receiving raw sensor data generated by a user device and of analyzing such data using a convolutional neural network or other algorithm-based system to detect gestures. A server may receive raw sensor data generated by one or both of the user device and the vehicle to analyze to detect location.

In some embodiments, cloud-based servers may collect user data from a number of vehicles. Such user data may be used to create and/or update artificial intelligence models. For example, sensor data from one or both of the vehicle and the user device could be sent to the server to be used as training material for a convolutional neural network. Updated models may be delivered to vehicles to be used as improved systems as described herein.

By comparing determined signal strength between a user device and one or more sensors on the vehicle, the location of the user device relative to the vehicle may be determined. In some embodiments, this determination may be made by the vehicle control system. In some embodiments, this determination may be made by the user device. In some embodiments, this determination may be made by a cloud-based server.

Using a determined signal strength of a single sensor, a distance between the user device and the vehicle may be determined and/or estimated. For example, if the signal strength is determined to be relatively high, the user device may be relatively close to the vehicle.

Using determined signal strengths for a number of sensors around a vehicle, a relative position and distance of the user device compared to the vehicle may be determined and/or estimated. For example, the user device may determine a signal strength between a sensor on the user device and one or more sensors on the vehicle, or the vehicle control system may determine a signal strength between one or more sensors on the vehicle and a sensor on the user device

Each Bluetooth sensor emits a noisy signal that relates to the distance of the user from that sensor. The determined signal strength may be used to determine/estimate a spatial location of the user device relative to the vehicle.

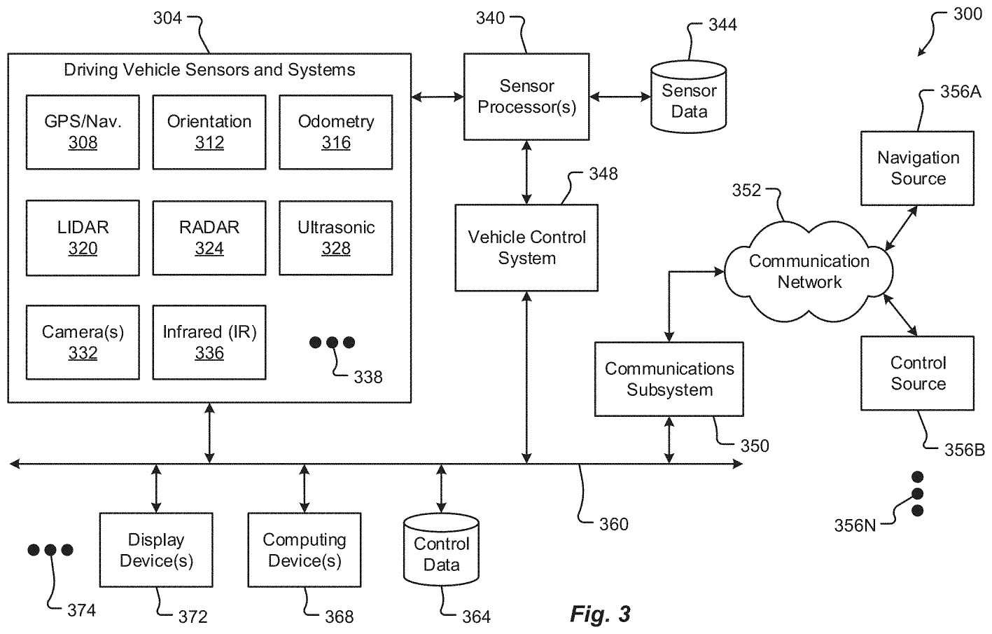

FIG. 3 is a block diagram of an embodiment of a communication environment 300 of the vehicle 100 in accordance with embodiments of the present disclosure. The communication system 300 may include one or more vehicle driving vehicle sensors and systems 304, sensor processors 340, sensor data memory 344, vehicle control system 348, communications subsystem 350, control data 364, computing devices 368, display devices 372, and other components 374 that may be associated with a vehicle 100. These associated components may be electrically and/or communicatively coupled to one another via at least one bus 360. In some embodiments, the one or more associated components may send and/or receive signals across a communication network 352 to at least one of a navigation source 356A, a control source 356B, or some other entity 356N.

In accordance with at least some embodiments of the present disclosure, the communication network 352 may comprise any type of known communication medium or collection of communication media and may use any type of protocols, such as SIP, TCP/IP, SNA, IPX, AppleTalk, and the like, to transport messages between endpoints. The communication network 352 may include wired and/or wireless communication technologies. The Internet is an example of the communication network 352 that constitutes an Internet Protocol (IP) network consisting of many computers, computing networks, and other communication devices located all over the world, which are connected through many telephone systems and other means.

The driving vehicle sensors and systems 304 may include at least one navigation 308 (e.g., global positioning system (GPS), etc.), orientation 312, odometry 316, LIDAR 320, RADAR 324, ultrasonic 328, camera 332, infrared (IR) 336, and/or other sensor or system 338. These driving vehicle sensors and systems 304 may be similar, if not identical, to the sensors and systems 116A-K, 112 described in conjunction with FIGS. 1 and 2.

The navigation sensor 308 may include one or more sensors having receivers and antennas that are configured to utilize a satellite-based navigation system including a network of navigation satellites capable of providing geolocation and time information to at least one component of the vehicle 100. Examples of the navigation sensor 308 as described herein may include, but are not limited to, at least one of Garmin® GLO™ family of GPS and GLONASS combination sensors, Garmin® GPS 15×™ family of sensors, Garmin® GPS 16×™ family of sensors with high-sensitivity receiver and antenna, Garmin® GPS 18× OEM family of high-sensitivity GPS sensors, Dewetron DEWE-VGPS series of GPS sensors, GlobalSat 1-Hz series of GPS sensors, other industry-equivalent navigation sensors and/or systems, and may perform navigational and/or geolocation functions using any known or future-developed standard and/or architecture.

The LIDAR sensor/system 320 may include one or more components configured to measure distances to targets using laser illumination. In some embodiments, the LIDAR sensor/system 320 may provide 3D imaging data of an environment around the vehicle 100. The imaging data may be processed to generate a full 360-degree view of the environment around the vehicle 100. The LIDAR sensor/system 320 may include a laser light generator configured to generate a plurality of target illumination laser beams (e.g., laser light channels). In some embodiments, this plurality of laser beams may be aimed at, or directed to, a rotating reflective surface (e.g., a mirror) and guided outwardly from the LIDAR sensor/system 320 into a measurement environment. The rotating reflective surface may be configured to continually rotate 360 degrees about an axis, such that the plurality of laser beams is directed in a full 360-degree range around the vehicle 100. A photodiode receiver of the LIDAR sensor/system 320 may detect when light from the plurality of laser beams emitted into the measurement environment returns (e.g., reflected echo) to the LIDAR sensor/system 320. The LIDAR sensor/system 320 may calculate, based on a time associated with the emission of light to the detected return of light, a distance from the vehicle 100 to the illuminated target. In some embodiments, the LIDAR sensor/system 320 may generate over 2.0 million points per second and have an effective operational range of at least 100 meters. Examples of the LIDAR sensor/system 320 as described herein may include, but are not limited to, at least one of Velodyne® LiDAR™ HDL-64E 64-channel LIDAR sensors, Velodyne® LiDAR™ HDL-32E 32-channel LIDAR sensors, Velodyne® LiDAR™ PUCK™ VLP-16 16-channel LIDAR sensors, Leica Geosystems Pegasus:Two mobile sensor platform, Garmin® LIDAR-Lite v3 measurement sensor, Quanergy M8 LiDAR sensors, Quanergy S3 solid state LiDAR sensor, LeddarTech® LeddarVU compact solid state fixed-beam LIDAR sensors, other industry-equivalent LIDAR sensors and/or systems, and may perform illuminated target and/or obstacle detection in an environment around the vehicle 100 using any known or future-developed standard and/or architecture.

The RADAR sensors 324 may include one or more radio components that are configured to detect objects/targets in an environment of the vehicle 100. In some embodiments, the RADAR sensors 324 may determine a distance, position, and/or movement vector (e.g., angle, speed, etc.) associated with a target over time. The RADAR sensors 324 may include a transmitter configured to generate and emit electromagnetic waves (e.g., radio, microwaves, etc.) and a receiver configured to detect returned electromagnetic waves. In some embodiments, the RADAR sensors 324 may include at least one processor configured to interpret the returned electromagnetic waves and determine locational properties of targets. Examples of the RADAR sensors 324 as described herein may include, but are not limited to, at least one of Infineon RASIC™ RTN7735PL transmitter and RRN7745PL/46PL receiver sensors, Autoliv ASP Vehicle RADAR sensors, Delphi L2C0051TR 77 GHz ESR Electronically Scanning Radar sensors, Fujitsu Ten Ltd. Automotive Compact 77 GHz 3D Electronic Scan Millimeter Wave Radar sensors, other industry-equivalent RADAR sensors and/or systems, and may perform radio target and/or obstacle detection in an environment around the vehicle 100 using any known or future-developed standard and/or architecture.

The ultrasonic sensors 328 may include one or more components that are configured to detect objects/targets in an environment of the vehicle 100. In some embodiments, the ultrasonic sensors 328 may determine a distance, position, and/or movement vector (e.g., angle, speed, etc.) associated with a target over time. The ultrasonic sensors 328 may include an ultrasonic transmitter and receiver, or transceiver, configured to generate and emit ultrasound waves and interpret returned echoes of those waves. In some embodiments, the ultrasonic sensors 328 may include at least one processor configured to interpret the returned ultrasonic waves and determine locational properties of targets. Examples of the ultrasonic sensors 328 as described herein may include, but are not limited to, at least one of Texas Instruments TIDA-00151 automotive ultrasonic sensor interface IC sensors, MaxBotix® MB8450 ultrasonic proximity sensor, MaxBotix® ParkSonar™-EZ ultrasonic proximity sensors, Murata Electronics MA40H1S-R open-structure ultrasonic sensors, Murata Electronics MA40S4R/S open-structure ultrasonic sensors, Murata Electronics MA58MF14-7N waterproof ultrasonic sensors, other industry-equivalent ultrasonic sensors and/or systems, and may perform ultrasonic target and/or obstacle detection in an environment around the vehicle 100 using any known or future-developed standard and/or architecture.

The camera sensors 332 may include one or more components configured to detect image information associated with an environment of the vehicle 100. In some embodiments, the camera sensors 332 may include a lens, filter, image sensor, and/or a digital image processer. It is an aspect of the present disclosure that multiple camera sensors 332 may be used together to generate stereo images providing depth measurements. Examples of the camera sensors 332 as described herein may include, but are not limited to, at least one of ON Semiconductor® MT9V024 Global Shutter VGA GS CMOS image sensors, Teledyne DALSA Falcon2 camera sensors, CMOSIS CMV50000 high-speed CMOS image sensors, other industry-equivalent camera sensors and/or systems, and may perform visual target and/or obstacle detection in an environment around the vehicle 100 using any known or future-developed standard and/or architecture.

The infrared (IR) sensors 336 may include one or more components configured to detect image information associated with an environment of the vehicle 100. The IR sensors 336 may be configured to detect targets in low-light, dark, or poorly-lit environments. The IR sensors 336 may include an IR light emitting element (e.g., IR light emitting diode (LED), etc.) and an IR photodiode. In some embodiments, the IR photodiode may be configured to detect returned IR light at or about the same wavelength to that emitted by the IR light emitting element. In some embodiments, the IR sensors 336 may include at least one processor configured to interpret the returned IR light and determine locational properties of targets. The IR sensors 336 may be configured to detect and/or measure a temperature associated with a target (e.g., an object, pedestrian, other vehicle, etc.). Examples of IR sensors 336 as described herein may include, but are not limited to, at least one of Opto Diode lead-salt IR array sensors, Opto Diode OD-850 Near-IR LED sensors, Opto Diode SA/SHA727 steady state IR emitters and IR detectors, FLIR® LS microbolometer sensors, FLIR® TacFLIR 380-HD InSb MWIR FPA and HD MWIR thermal sensors, FLIR® VOx 640×480 pixel detector sensors, Delphi IR sensors, other industry-equivalent IR sensors and/or systems, and may perform IR visual target and/or obstacle detection in an environment around the vehicle 100 using any known or future-developed standard and/or architecture.

In some embodiments, the driving vehicle sensors and systems 304 may include other sensors 338 and/or combinations of the sensors 308-336 described above. Additionally or alternatively, one or more of the sensors 308-336 described above may include one or more processors configured to process and/or interpret signals detected by the one or more sensors 308-336. In some embodiments, the processing of at least some sensor information provided by the vehicle sensors and systems 304 may be processed by at least one sensor processor 340. Raw and/or processed sensor data may be stored in a sensor data memory 344 storage medium. In some embodiments, the sensor data memory 344 may store instructions used by the sensor processor 340 for processing sensor information provided by the sensors and systems 304. In any event, the sensor data memory 344 may be a disk drive, optical storage device, solid-state storage device such as a random access memory (“RAM”) and/or a read-only memory (“ROM”), which can be programmable, flash-updateable, and/or the like.

The vehicle control system 348 may receive processed sensor information from the sensor processor 340 and determine to control an aspect of the vehicle 100. Controlling an aspect of the vehicle 100 may include presenting information via one or more display devices 372 associated with the vehicle, sending commands to one or more computing devices 368 associated with the vehicle.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

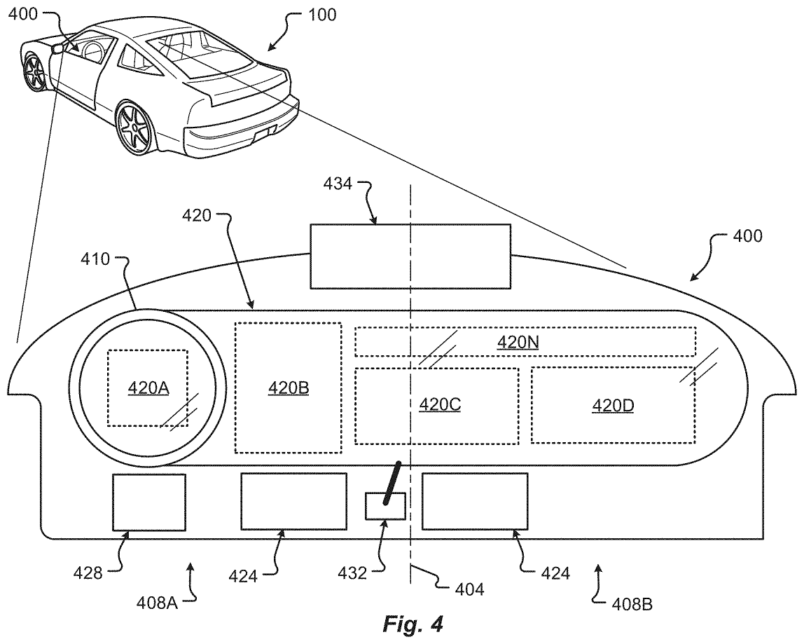

FIG. 4 shows one embodiment of the instrument panel 400 of the vehicle 100. The instrument panel 400 of vehicle 100 comprises a steering wheel 410, a vehicle operational display 420 (e.g., configured to present and/or display driving data such as speed, measured air resistance, vehicle information, entertainment information, etc.), one or more auxiliary displays 424 (e.g., configured to present and/or display information segregated from the operational display 420, entertainment applications, movies, music, etc.), a heads-up display 434 (e.g., configured to display any information previously described including, but in no way limited to, guidance information such as route to destination, or obstacle warning information to warn of a potential collision, or some or all primary vehicle operational data such as speed, resistance, etc.), a power management display 428 (e.g., configured to display data corresponding to electric power levels of vehicle 100, reserve power, charging status, etc.), and an input device 432 (e.g., a controller, touchscreen, or other interface device configured to interface with one or more displays in the instrument panel or components of the vehicle 100. The input device 432 may be configured as a joystick, mouse, touchpad, tablet, 3D gesture capture device, etc.). In some embodiments, the input device 432 may be used to manually maneuver a portion of the vehicle 100 into a charging position (e.g., moving a charging plate to a desired separation distance, etc.).

While one or more of displays of instrument panel 400 may be touch-screen displays, it should be appreciated that the vehicle operational display may be a display incapable of receiving touch input. For instance, the operational display 420 that spans across an interior space centerline 404 and across both a first zone 408A and a second zone 408B may be isolated from receiving input from touch, especially from a passenger. In some cases, a display that provides vehicle operation or critical systems information and interface may be restricted from receiving touch input and/or be configured as a non-touch display. This type of configuration can prevent dangerous mistakes in providing touch input where such input may cause an accident or unwanted control.

In some embodiments, one or more displays of the instrument panel 400 may be mobile devices and/or applications residing on a mobile device such as a smart phone. Additionally or alternatively, any of the information described herein may be presented to one or more portions 420A-N of the operational display 420 or other display 424, 428, 434. In one embodiment, one or more displays of the instrument panel 400 may be physically separated or detached from the instrument panel 400. In some cases, a detachable display may remain tethered to the instrument panel.

The portions 420A-N of the operational display 420 may be dynamically reconfigured and/or resized to suit any display of information as described. Additionally or alternatively, the number of portions 420A-N used to visually present information via the operational display 420 may be dynamically increased or decreased as required, and are not limited to the configurations shown.

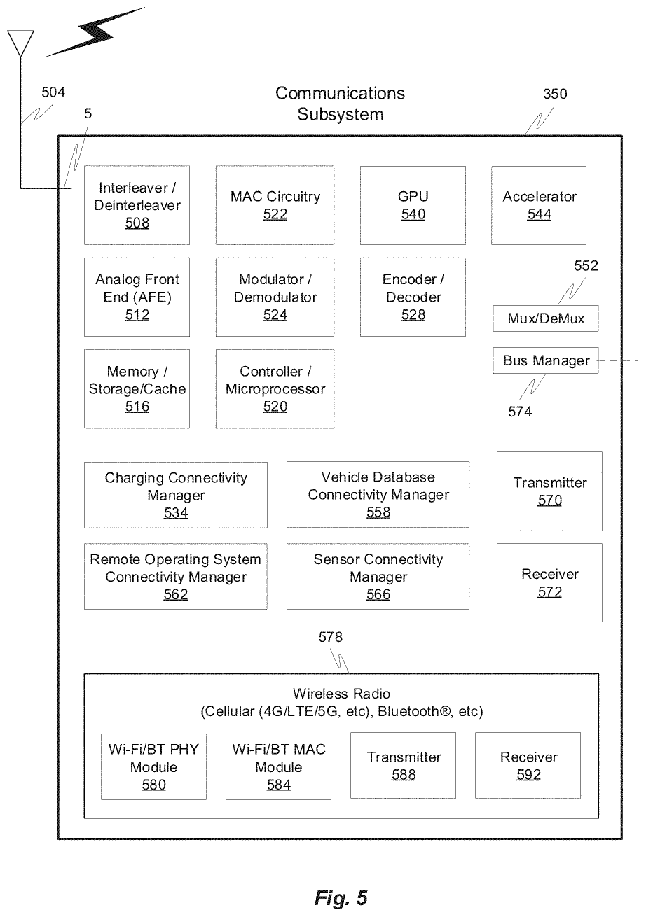

FIG. 5 illustrates a hardware diagram of communications componentry that can be optionally associated with the vehicle 100 in accordance with embodiments of the present disclosure.

The communications componentry can include one or more wired or wireless devices such as a transceiver(s) and/or modem that allows communications not only between the various systems disclosed herein but also with other devices, such as devices on a network, and/or on a distributed network such as the Internet and/or in the cloud and/or with other vehicle(s).

The communications subsystem 350 can also include inter- and intra-vehicle communications capabilities such as hotspot and/or access point connectivity for any one or more of the vehicle occupants and/or vehicle-to-vehicle communications.

Additionally, and while not specifically illustrated, the communications subsystem 350 can include one or more communications links (that can be wired or wireless) and/or communications busses (managed by the bus manager 574), including one or more of CANbus, OBD-II, ARCINC 429, Byteflight, CAN (Controller Area Network), D2B (Domestic Digital Bus), FlexRay, DC-BUS, IDB-1394, IEBus, I2C, ISO 9141-1/-2, J1708, J1587, J1850, J1939, ISO 11783, Keyword Protocol 2000, LIN (Local Interconnect Network), MOST (Media Oriented Systems Transport), Multifunction Vehicle Bus, SMARTwireX, SPI, VAN (Vehicle Area Network), and the like or in general any communications protocol and/or standard(s).

The various protocols and communications can be communicated one or more of wirelessly and/or over transmission media such as single wire, twisted pair, fiber optic, IEEE 1394, MIL-STD-1553, MIL-STD-1773, power-line communication, or the like. (All of the above standards and protocols are incorporated herein by reference in their entirety).

The communications subsystem 350, in addition to well-known componentry (which has been omitted for clarity), includes interconnected elements including one or more of: one or more antennas 504, an interleaver/deinterleaver 508, an analog front end (AFE) 512, memory/storage/cache 516, controller/microprocessor 520, MAC circuitry 522, modulator/demodulator 524, encoder/decoder 528, a plurality of connectivity managers 534, 558, 562, 566, GPU 540, accelerator 544, a multiplexer/demultiplexer 552, transmitter 570, receiver 572 and wireless radio 578 components such as a Wi-Fi PHY/Bluetooth® module 580, a Wi-Fi/BT MAC module 584, transmitter 588 and receiver 592. The various elements in the device 350 are connected by one or more links/busses 5 (not shown, again for sake of clarity).

The device 350 can have one more antenna(s) 504, for use in wireless communications such as multi-input multi-output (MIMO) communications, multi-user multi-input multi-output (MU-MIMO) communications Bluetooth®, LTE, 4G, 5G, Near-Field Communication (NFC), etc., and in general for any type of wireless communications. The antenna(s) 504 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users for example within the vehicle 100 and/or in another vehicle.

Antenna(s) 504 generally interact with the Analog Front End (AFE) 512, which is needed to enable the correct processing of the received modulated signal and signal conditioning for a transmitted signal. The AFE 512 can be functionally located between the antenna and a digital baseband system in order to convert the analog signal into a digital signal for processing and vice-versa.

The subsystem 350 can also include a controller/microprocessor 520 and a memory/storage/cache 516. The subsystem 350 can interact with the memory/storage/cache 516 which may store information and operations necessary for configuring and transmitting or receiving the information described herein. The memory/storage/cache 516 may also be used in connection with the execution of application programming or instructions by the controller/microprocessor 520, and for temporary or long-term storage of program instructions and/or data. As examples, the memory/storage/cache 520 may comprise a computer-readable device, RAM, ROM, DRAM, SDRAM, and/or other storage device(s) and media.

The controller/microprocessor 520 may comprise a general purpose programmable processor or controller for executing application programming or instructions related to the subsystem 350. Furthermore, the controller/microprocessor 520 can perform operations for configuring and transmitting/receiving information as described herein. The controller/microprocessor 520 may include multiple processor cores, and/or implement multiple virtual processors. Optionally, the controller/microprocessor 520 may include multiple physical processors. By way of example, the controller/microprocessor 520 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The subsystem 350 can further include a transmitter 570 and receiver 572 which can transmit and receive signals, respectively, to and from other devices, subsystems and/or other destinations using the one or more antennas 504 and/or links/busses. Included in the subsystem 350 circuitry is the medium access control or MAC Circuitry 522. MAC circuitry 522 provides for controlling access to the wireless medium. In an exemplary embodiment, the MAC circuitry 522 may be arranged to contend for the wireless medium and configure frames or packets for communicating over the wired/wireless medium.

The vehicle database connectivity manager 558 allows the subsystem to receive and/or share information stored in the vehicle database. This information can be shared with other vehicle components/subsystems and/or other entities, such as third parties and/or charging systems. The information can also be shared with one or more vehicle occupant devices, such as an app (application) on a mobile device the driver uses to track information about the vehicle 100 and/or a dealer or service/maintenance provider. In general, any information stored in the vehicle database can optionally be shared with any one or more other devices optionally subject to any privacy or confidentially restrictions.

The remote operating system connectivity manager 562 facilitates communications between the vehicle 100 and any one or more autonomous vehicle systems. These communications can include one or more of navigation information, vehicle information, other vehicle information, weather information, occupant information, or in general any information related to the remote operation of the vehicle 100.

The sensor connectivity manager 566 facilitates communications between any one or more of the vehicle sensors (e.g., the driving vehicle sensors and systems 304, etc.) and any one or more of the other vehicle systems. The sensor connectivity manager 566 can also facilitate communications between any one or more of the sensors and/or vehicle systems and any other destination, such as a service company, app, or in general to any destination where sensor data is needed.

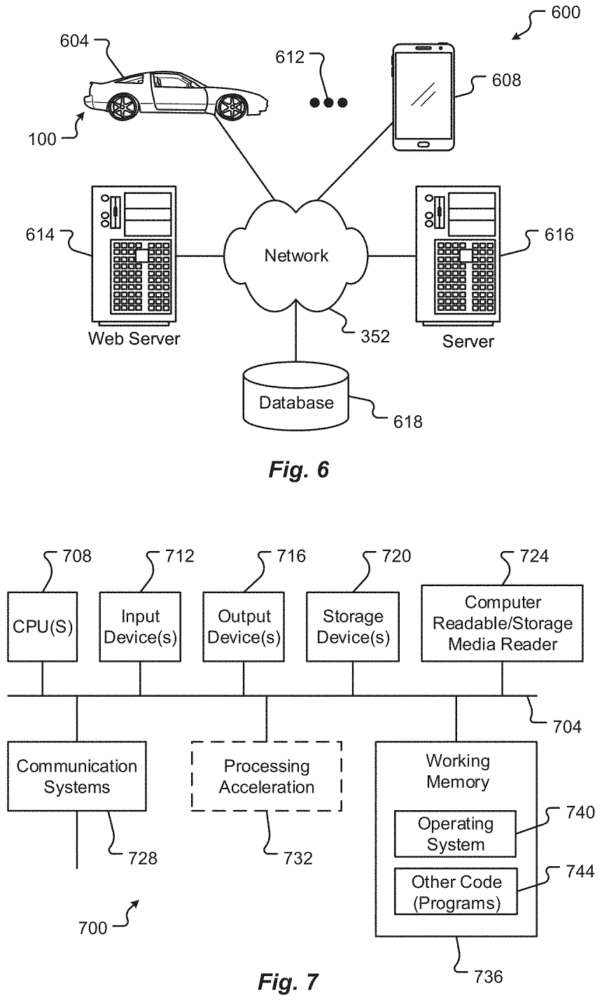

FIG. 6 illustrates a block diagram of a computing environment 600 that may function as the servers, user computers, or other systems provided and described herein. The computing environment 600 includes one or more user computers, or computing devices, such as a vehicle computing device 604, a communication device 608, and/or more 612. The computing devices 604, 608, 612 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 604, 608, 612 may also have any of a variety of applications, including for example, database client and/or server applications, and web browser applications. Alternatively, the computing devices 604, 608, 612 may be any other electronic device, such as a thin-client computer, Internet-enabled mobile telephone, and/or personal digital assistant, capable of communicating via a network 352 and/or displaying and navigating web pages or other types of electronic documents. Although the exemplary computing environment 600 is shown with two computing devices, any number of user computers or computing devices may be supported.

The computing environment 600 may also include one or more servers 614, 616. In this example, server 614 is shown as a web server and server 616 is shown as an application server. The web server 614, which may be used to process requests for web pages or other electronic documents from computing devices 604, 608, 612.

The computing environment 600 may also include a database 618. The database 618 may reside in a variety of locations. By way of example, database 618 may reside on a storage medium local to (and/or resident in) one or more of the computers 604, 608, 612, 614, 616. Alternatively, it may be remote from any or all of the computers 604, 608, 612, 614, 616, and in communication (e.g., via the network 352) with one or more of these.

FIG. 7 illustrates one embodiment of a computer system 700 upon which the servers, user computers, computing devices, or other systems or components described above may be deployed or executed. The computer system 700 is shown comprising hardware elements that may be electrically coupled via a bus 704. The hardware elements may include one or more central processing units (CPUs) 708; one or more input devices 712 (e.g., a mouse, a keyboard, etc.); and one or more output devices 716 (e.g., a display device, a printer, etc.). The computer system 700 may also include one or more storage devices 720. By way of example, storage device(s) 720 may be disk drives, optical storage devices, solid-state storage devices such as a random access memory (“RAM”) and/or a read-only memory (“ROM”), which can be programmable, flash-updateable and/or the like.

The computer system 700 may additionally include a computer-readable storage media reader 724; a communications system 728 (e.g., a modem, a network card (wireless or wired), an infra-red communication device, etc.); and working memory 736, which may include RAM and ROM devices as described above. The computer system 700 may also include a processing acceleration unit 732, which can include a DSP, a special-purpose processor, and/or the like.

The computer-readable storage media reader 724 can further be connected to a computer-readable storage medium, together (and, optionally, in combination with storage device(s) 720) comprehensively representing remote, local, fixed, and/or removable storage devices plus storage media for temporarily and/or more permanently containing computer-readable information. The communications system 728 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information.

The computer system 700 may also comprise software elements, shown as being currently located within a working memory 736, including an operating system 740 and/or other code 744. It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 340, 708 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

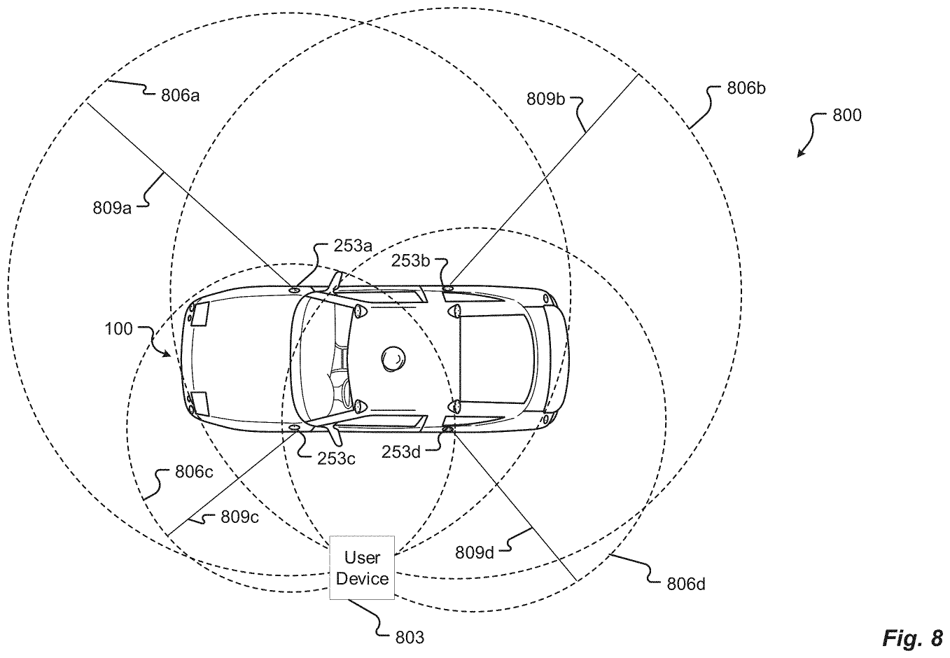

As illustrated by the environment 800 of FIG. 8, a control system of a vehicle 100 may be capable of determining a location of a user device 803. The user device 803 may emit a signal which may be received by one or more of the sensors 253a-253d. A signal strength of each signal received by each sensor may be determined by the vehicle control system. A stronger signal may be associated with a closer user device, while a weaker signal may be associated with a further user device. In some embodiments, the vehicle control system may determine a distance 809a-809d between each sensor 253a-253d and the user device 803 based on the signal strength for signals sent from the user device 803 as received by each sensor 253a-253d. The spatial location of the user device 803 in relation to the vehicle 100 may be estimated by the vehicle control system by locating an intersection of circles 806a-806d, in which each circle 806a-806d comprises a center at the location of a corresponding sensor 253a-253d and a radius 809a-809d corresponding to the estimated distance for each corresponding sensor 253a-253d.

In some embodiments, in the alternative or additionally, the user device and the vehicle could each determine its location via other means such as GPS, WAN triangulation, etc. These location determinations could be compared to determine if the user device is near the vehicle.

In some embodiments, the vehicle system may be capable of determining a motion of the user device. For example, a changing position of the user device relative to the vehicle could indicate the user of the user device is nearing the vehicle or traveling away from the vehicle, nearing a particular door of the vehicle, or just walking by the vehicle.

Using these distance estimations/determinations, a current location of the user device relative to the vehicle may be determined/estimated by the processor.

The relative spatial location of the user device and the distance of the user device from the vehicle may be found by fusing sensor information from low-power, low-cost Bluetooth sensors mounted at the corners of the vehicle.

A Bluetooth module of a user device receive noisy signals sent from Bluetooth sensors mounted around the vehicle via an antenna. The signals emitted by the vehicle sensors may be received by the user device. The strength of the signal as received by each of the sensors on the vehicle may relate to the distance of the user from that sensor. These sensor readings may be filtered using Kalman filters or particle filters to reduce noise, and combined using trilateration or nonlinear least squares to estimate the location of the user with respect to the vehicle.

Both trilateration and nonlinear least squares may involve drawing a circle with radius equal to the expected distance from each sensor and finding the intersection of the circles, as shown in the figure below. Nonlinear least squares involve iteratively resizing these circles to find the location of the user in the presence of sensor noise.

Using this determined/estimated location, the processor of the user device may be capable of determining/estimating whether the user device is particularly close to a particular portion of the vehicle, for example one of the doors, the hood, the trunk and/or the charger port.

To estimate motion of the user device, the processor of the user device may also be capable of receiving updated signals from one or more of the sensors and from the updated signals may be capable of determining a trajectory of the user device. For example, a user walking to or from the vehicle may be detected. Speed and/or acceleration of a user may also be detected, determined, and/or estimated.

The particular door of the vehicle accessible using the gesture recognition system can also be decided with knowledge of the bearing, velocity, and/or gait of the user captured by the proximity detection sensors or other sensors mounted on the vehicle.

A user device may be associated with one or more users. A user may be associated with a user profile. User profile data may be stored in memory one or more of onboard the vehicle and on a cloud-based server. Such profile data may be synced between the two locations periodically or continuously. User profile data may comprise one or more of access levels for one or more vehicles, user preferences, and/or other user information. In communicating with a user device, the vehicle control system and/or the user device may be capable of determining an identity of the user of the user device.

In some embodiments, determining an identity of the user of the user device may comprise analyzing one or more of a bearing, velocity, and/or gait of the user. Bearing, velocity, and/or gait analysis may be made based on or in conjunction with data received from sensors onboard the vehicle.

In some embodiments, determining an identity of the user of the user device may comprise detecting a user device ID. The user device may require one or more of a password, thumbprint, facial recognition, etc., to verify the user.

A user ID may be used to determine an access level to the vehicle for the particular user. For example, after determining a user ID of a user attempting to access the vehicle, the vehicle control system may consult an internal or network-based database to determine user access and/or preferences. As can be appreciated, one or both of the localization and gesture recognition systems may be deployed in an off-network scenario, wherein the communication between the vehicle and the user is through one or more Bluetooth connections.

Access levels may be related to one or more features of the vehicle, for example vehicle power, driving capabilities, air conditioning, entertainment system access, etc.

User IDs may be associated with one or more types of users, for example, an owner-driver of the vehicle, an owner-nondriver, a non-owner-driver, a non-owner-non-driver, a valet, an adult, a child, authorized, unauthorized, special rules, a user with preferences, etc.

In some embodiments, the vehicle control system may execute a gesture recognition system. In some embodiments, a gesture recognition system may be executed by an application executing on a user device. For example, one or both of a vehicle control system and an application executing on a user device may determine a distance of the user device from the vehicle. The one or both of a vehicle control system and an application executing on a user device may further determine a location of the user device relative to the vehicle using a method of localization. Depending on the relative position of the user device in comparison to the vehicle, the proximity of the vehicle to the user device, and/or whether the user device is approaching or moving away from the vehicle, the gesture recognition module in one or both of the device and the vehicle control system could be activated. The gesture recognition algorithms may be capable of uniquely identifying a user's gesture, or signature pattern, of locking and/or unlocking the vehicle. Machine learning algorithms may be used to train the device to accurately determine the user's intent of lock/unlock in the vicinity of the vehicle.

In some embodiments, the gesture recognition system may be performed by one or more of the vehicle control system, a cloud-based server, and/or a user device such as a smartphone.

A gesture recognition system may comprise receiving sensor data from a user device. Sensor data may be from one or more sensors of a user device. The one or more sensors may be one or more of an accelerometer, a gyroscopic sensor, a microphone, a camera, and/or other sensors.

In some embodiments, the one or more sensors may be activated following the user device entering within a threshold distance of a vehicle. For example, the vehicle may use the above-discussed location detecting system to detect a user device within a predetermined distance of the vehicle. The vehicle control system may determine the user device belongs to an authorized user. The vehicle control system may, after determining the user device is within a threshold distance and determining the user device is associated with an authorized user, instruct the user device to begin collecting sensor data.

A gesture recognition system may allow a user to activate one or more vehicle features by performing a gesture with a user device. Features activatable by the gesture recognition system may be, for example, to lock/unlock one or all doors, start the vehicle, set comfort preferences, or other functions.

In some embodiments, sensor data from a user device may be received by the vehicle via one of the same sensors used to locate the user device.

In some embodiments, detecting the gesture comprises receiving raw accelerometer data from a device associated with the user.

In some embodiments, a gesture may be one or more of a knock on a device associated with the user and/or a movement of the device. For example, a user may physically wave the user device through the air in a particular pattern or tap on the device using his/her hand.

In some embodiments, detecting the gesture further comprises analyzing the raw accelerometer data with a convolutional neural network.

When a user is sufficiently close to the vehicle. He/she can express the intention of whether to access the vehicle or not. This is done by user doing a particular gesture on their smart cell phone, for example, knock on the phone, flip the phone by 180 degree, etc. In this case, the vehicle control system may ask the following question: Did the user just present the intention to open the car door through certain predefined gesture? We will discuss the underlying model to answer such question.

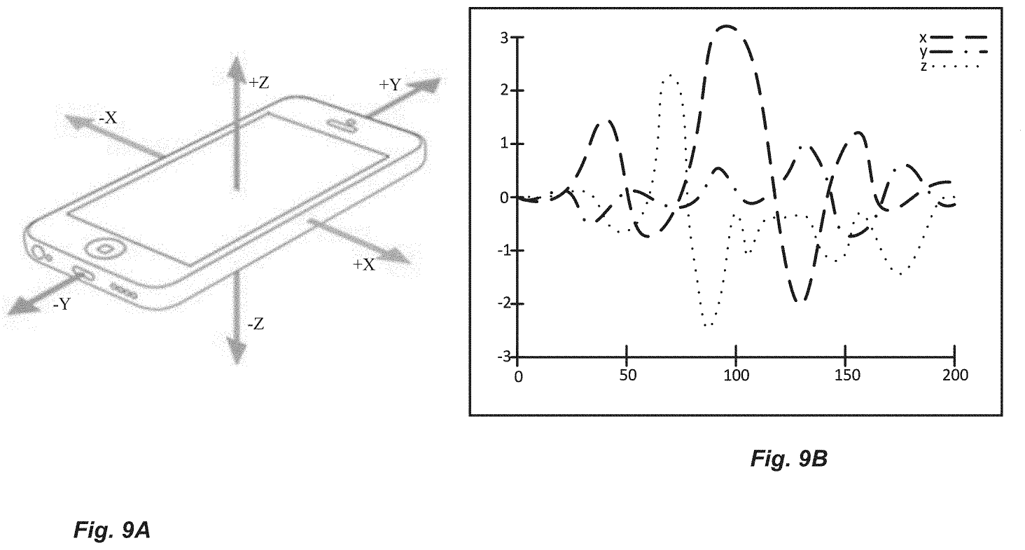

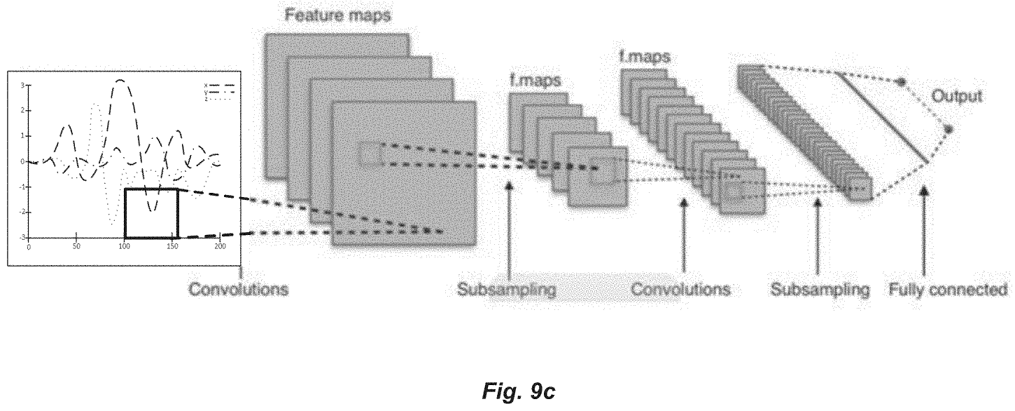

Accelerometer information may be used in gesture recognition. An accelerometer is a compact device embedded in the cellphone to measure non-gravitational acceleration. When the object the accelerometer is integrated into goes from a standstill to any velocity, the accelerometer is designed to respond to the vibrations associated with such movement. The signals of accelerometer may be in relation to three dimensions: x, y, and z as shown in FIG. 9A.

The raw signal received can be noisy. In some embodiments, the raw signal may be processed with a high pass filter. Next, a control system may perform data segmentation to divide the signal into segments which each segment contains only one meaningful gesture. Finally, the control system may apply up/down sampling to signals that each gesture segment is of fixed length. This will be the input of the gesture recognition model, e.g., a 3 by 200 multi-array. Signals may be from 3 dimensions (i.e., x, y, and z). Each dimension may be a time series of, for example, 200 data points.

As illustrated in FIG. 9B, changes in the orientation of the user device over a particular timeframe may be recorded on a table. In some embodiments, the table may be a two-dimensional axis with time on one axis and positive/negative changes in position on another axis. A line may be plotted for each of the x, y, and z dimensions. As an orientation sensor within the user device is tilted, the x, y, and z dimensions may change. In this way, particular gestures made by a user with the user device could result in particular patterns on a table as illustrated in FIG. 9B.

For example, a user may make a gesture by knocking a particular number of times on the user device. Other gestures may include waving the device in a particular pattern or other motions. Different gestures may be used for different functions. For example, knocking twice on a user device may result in unlocking doors and knocking three times on a user device may result in starting the vehicle.

In some embodiments, a convolutional neural network for gesture recognition may be developed. The input of the model may, for example, be a 3 by 200 multi-array corresponding to a gesture performed by a user of a user device. The output of the model may be the probability that a verified gesture type is performed by the user, p, and 1-p. FIG. 9C demonstrates this model.

In some embodiments, the gesture recognition algorithm may have two phases: training and testing. During training, a set of labeled gestures may be collected. For example, to create a model, 2000 feature gestures (e.g., knocks on the phone), and 2000 different gestures (e.g., shaking, walking, etc.) may be collected. The signals of the labeled gestures may be preprocessed and provided as inputs of the model. The outputs of the model may be the labels, e.g., 1 for feature gestures, 0 for not feature gestures.

During training, the gesture recognition algorithm may update the convolutional neural network model parameters based on provided inputs and outputs. During the testing phase, a new set of gesture inputs may be given. Based on the trained model, the convolutional neural network model may output the probabilities of the feature gesture.

A given gesture may be categorized as a feature gesture if p>0.5. Otherwise, the presence of feature gesture may be denied. Next, the true labels of the gestures may be provided. Based on the labels of the gestures, the control system may evaluate the performance of the trained convolutional neural network model through false-positives and false-negatives. If the performance of the convolutional neural network model is not as desired, the model parameters may be adjusted and the convolutional neural network model may be retrained until the desired performance is achieved.

A convolutional neural network model may comprise several layers as illustrated in FIG. 9C and as described below.

A first layer may be a two-dimensional convolutional neural network (or ConvNet) layer. A two-dimensional ConvNet layer may be used for extracting high-level features. The input of the first layer may be a small sample of a sensor reading over a particular segment of time as illustrated in FIG. 9B.

The output of the first, 2D ConvNet, layer may be input into a second layer. The second layer may be another two-dimensional layer with maxpooling. The 2D maxpooling layer may perform a down-sampling operation.

The output of the 2D maxpooling layer may be used as an input for a second 2D ConvNet layer. The second 2D ConvNet layer may be used for extracting low-level features.

The output of the second 2D ConvNet layer may be input into a second maxpooling layer. The second maxpooling layer may be used to further reduce the dimension.

Finally, the output of the second maxpooling layer may be used as an input to a fully-connected layer that computes the probability for each of the two classes.

In this way, an algorithm capable of effectively classifying gestures, given that personal differences exist between users, may be created. The algorithm may also be capable of being customized for a particular user of a vehicle.

In some embodiments, a method of activating one or more features of a vehicle may be implemented using one or more of the location detection system, user identification system, and/or the gesture recognition system.

While the method may be described herein in terms of being executed by a vehicle control system, it should be appreciated, as discussed above, each of the location detection system, user identification system, and/or the gesture recognition system may be performed by one or more of a user device, a vehicle, control system, and/or a cloud-based server.

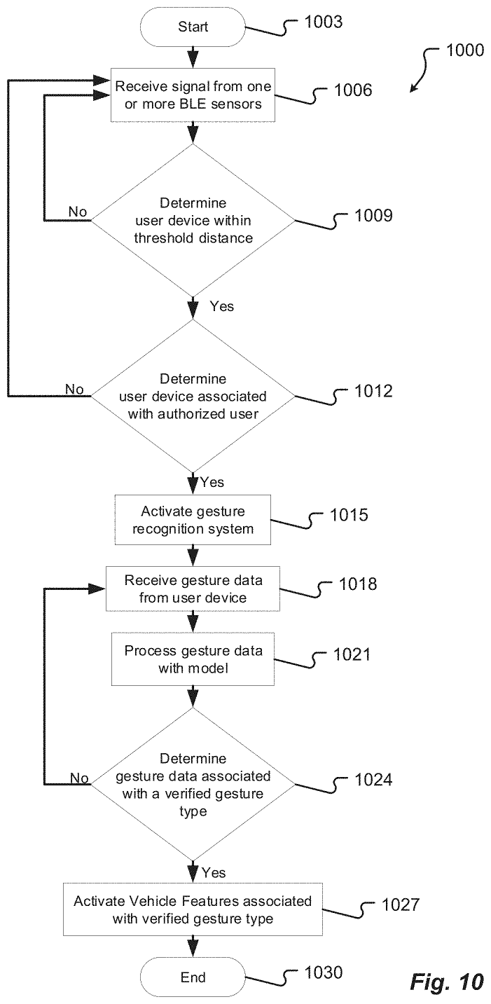

The method of activating one or more features of a vehicle may be as illustrated by the flowchart 1000 of FIG. 10. While the steps of the method are illustrated in a particular order, it should be appreciated that the steps may be performed in other orders. Similar methods may also be performed omitting certain steps and/or adding other steps.

As illustrated in FIG. 10, a method 1000 may begin at step 1003 in which a user using a user device is outside a vehicle. The user device may comprise one or more sensors, for example, an accelerometer, a gyroscope, a GPS, Bluetooth, NFC, etc. The user device may comprise an antenna capable of receiving high and/or low frequency signals from one or more BLE emitting sensors such as iBeacon BLE sensors. The vehicle may be as illustrated in FIG. 1 and may comprise one or more sensors placed around the vehicle, as illustrated in FIG. 2B.

The method 1000 may be initiated upon a determination that the user device is within a particular distance of the vehicle. For example, a location of both the vehicle and the user device may be made using GPS systems of both devices. Additionally, or in the alternative, the proximity of the user device to the vehicle may be determined using one or more BLE sensors of the vehicle. The user device may receive one or more signals from the BLE sensors and may be capable of determining the distance of the user device from the vehicle. If it is determined that the user device is within a particular distance of the vehicle, the method 1000 may begin.

In step 1006, the user device may receive one or more signals from BLE sensors on the vehicle. For example, one or more sensors of the vehicle, such as illustrated in FIG. 2B, may communicate with and/or otherwise transmit a signal to an antenna of a user device. In some embodiments, this communication may occur by the user device executing an application to receive the one or more signals from the vehicle. Additionally, or in the alternative, one or more Bluetooth sensors of the vehicle may receive one or more signals from the user device.

In step 1009, an application executing on the user device may determine whether the user device is within a threshold distance of the vehicle. In some embodiments, this threshold distance question may be satisfied if any signal from a BLE sensor of the vehicle is received by the user device at all, i.e. the threshold distance may be set at infinity. In some embodiments, the threshold distance may be set at a particular non-zero distance, such as, for example, 20 feet. In some embodiments, the step 1006 of receiving the signals by the user device may be performed only after the step 1009 of determining whether the user device is within a threshold distance.

Determining the distance between the vehicle and the user device may comprise determining a signal strength of one or more of the signals received by the user device. Signal strength may be measured as a percentage of a full-strength signal. Multiple sensors on a vehicle may transmit signals to a user device. The differences between the strengths of signals received from each sensor may be analyzed by the user device to determine a spatial location of the user device relative to the vehicle using a localization system such as triangulation.

If the vehicle is determined to not be within the threshold distance of the user device in step 1009, the method 1000 may comprise returning to step 1006 in which the vehicle control system continues to transmit BLE signals towards the user device.

In step 1012, if the user device determines it is within the threshold distance of the vehicle in step 1009, the user device next may determine whether the user device is associated with an authorized user of the vehicle. For example, communication between the user device and the vehicle sensors may comprise information associated with one or more of a user device ID and a user ID.

User device IDs may be, for example, a MAC address, or a unique identification name, or other authorization means. A user ID may comprise a username or other identification. User device IDs and user IDs may be a part of a packet sent from the user device to or from the vehicle via one or more sensors of the vehicle.

Determining whether the user device is associated with an authorized user of the vehicle may comprise comparing the user device ID and/or the user ID to one or more of an internal user database and/or a database on a cloud-based server. Using a cloud-based server to verify whether a user device is associated with an authorized user of the vehicle may comprise sending the user ID and/or user device ID to the server. The server may consult a database of authorized users to verify whether the user ID and/or user device ID is associated with the particular vehicle.

If the user device is not determined to be associated with an authorized user in step 1012, the method 1000 may simply end. If, on the other hand, the user device is determined to be associated with an authorized user in step 1012, the method 1000 may continue to step 1015.

In step 1015, the user device may activate a gesture recognition system. Activating the gesture recognition system may comprise activating a sensor of the user device such as an accelerometer and/or gyroscope. For example, the user device may execute a gesture recognition application. Accelerometer and/or gyroscopic sensor data may be collected by the user device. The user device may transmit such data to the vehicle over a wireless communications system such as Bluetooth or other LAN or WAN system.

In step 1018, the vehicle control system may receive gesture data from the user device. For example, raw sensor data sent from the user device to the vehicle may be received by sensors of the vehicle. The raw sensor data may be constantly or periodically received by the vehicle during the time in which the user device is within the threshold distance.

In step 1021, the vehicle control system may process the received gesture data with a convolutional neural network. Raw sensor data may be sampled as it is received by the vehicle. In some embodiments, time segments of a particular duration may be sampled and used as inputs into a neural network. Time segments may be, for example, one second windows of raw data. The raw sensor data may be pre-processed using one or more filters. The sensor data, raw or processed, may be analyzed using a multi-layer neural network such as a convolutional neural network. The network model may be created and trained by a network server and transmitted to the vehicle. In some embodiments, real-world data may be transmitted to the network server and used to update the model. Models may be customized for a particular vehicle, a particular user, or a group of users.

In step 1024, the vehicle control system may determine whether the received gesture data is associated with a verified gesture type. A number of models may be used to compare the received sensor data with a number of different types of gestures and/or different users. For example, a single sample of gesture data may be used as an input into multiple convolutional neural networks, in which each tests the input to determine if the gesture data is associated with a particular gesture. Each particular gesture may be a different command and may take into consideration particularities between different users.

If the gesture data is determined not to be associated with a verified gesture type in step 1024, the method 1000 may return to step 1018 and wait for new gesture data to be received from a user device. If, on the other hand, the gesture data is determined to be associated with a verified gesture type in step 1024, the method 1000 may continue to step 1027.

In step 1027, the vehicle control system may activate one or more features of the vehicle based on the gesture. For example, if the gesture data is determined to be associated with an unlock gesture, the vehicle control system may unlock one or more doors. In step 1030, the method 1000 may end.

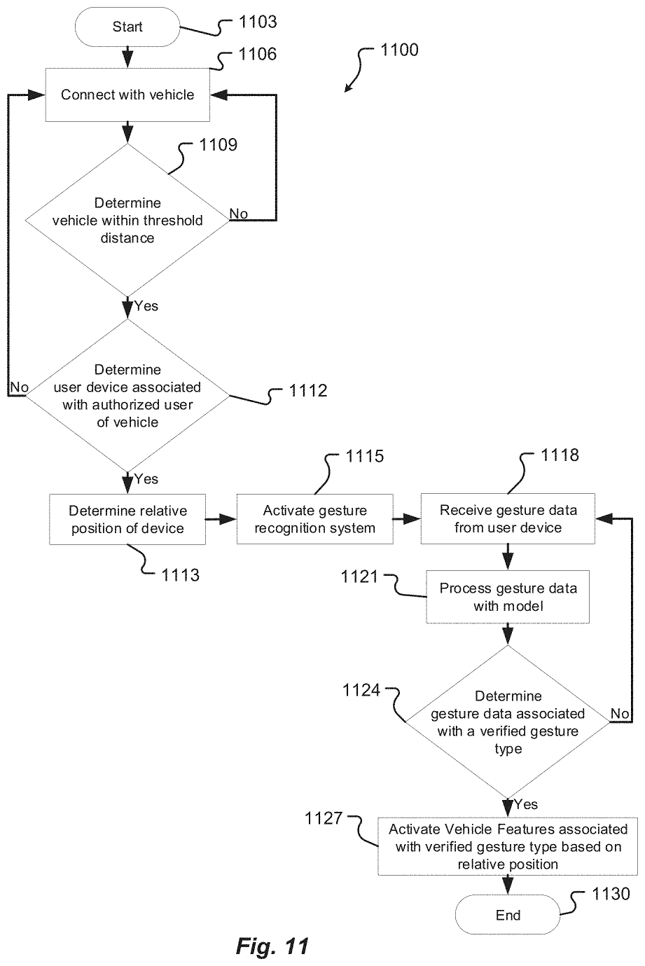

As illustrated in FIG. 11, a method 1100 may comprise activating one or more vehicle features based on not only the user identity and the gesture but also the location of the user relative to the vehicle.

In step 1106, the user device may receive one or more signals from sensors on the vehicle. For example, one or more sensors of the vehicle, such as illustrated in FIG. 2B, may communicate with and/or otherwise transmit a signal to an antenna of a user device. In some embodiments, this communication may occur by the user device executing an application to receive the one or more signals from the vehicle. Additionally, or in the alternative, one or more Bluetooth sensors of the vehicle may receive one or more signals from the user device.

In step 1109, an application executing on the user device may determine whether the user device is within a threshold distance of the vehicle. In some embodiments, this threshold distance question may be satisfied if any signal from a BLE sensor of the vehicle is received by the user device at all, i.e. the threshold distance may be set at infinity. In some embodiments, the threshold distance may be set at a particular non-zero distance, such as, for example, 20 feet. In some embodiments, the step 1106 of receiving the signals by the user device may be performed only after the step 1109 of determining whether the user device is within a threshold distance.

Determining the distance between the vehicle and the user device may comprise determining a signal strength of one or more of the signals received by the user device. Signal strength may be measured as a percentage of a full-strength signal. Multiple sensors on a vehicle may transmit signals to a user device. The differences between the strengths of signals received from each sensor may be analyzed by the user device to determine a spatial location of the user device relative to the vehicle using a localization system such as triangulation.

If the user device is determined to not be within the threshold distance in step 1109, the method 1100 may comprise returning to step 1106 in which the vehicle control system continues to transmit BLE signals towards the user device.

In step 1112, if the user device determines it is within the threshold distance of the vehicle in step 1109, the user device next may determine whether the user device is associated with an authorized user of the vehicle. For example, communication between the user device and the vehicle sensors may comprise information associated with one or more of a user device ID and a user ID.

User device IDs may be, for example, a MAC address, or a unique identification name, or other authorization means. A user ID may comprise a username or other identification. User device IDs and user IDs may be a part of a packet sent from the user device to or from the vehicle via one or more sensors of the vehicle.

Determining whether the user device is associated with an authorized user of the vehicle may comprise comparing the user device ID and/or the user ID to one or more of an internal user database and/or a database on a cloud-based server. Using a cloud-based server to verify whether a user device is associated with an authorized user of the vehicle may comprise sending the user ID and/or user device ID to the server. The server may consult a database of authorized users to verify whether the user ID and/or user device ID is associated with the particular vehicle.

If the user device is not determined to be associated with an authorized user in step 1112, the method 1100 may simply end. If, on the other hand, the user device is determined to be associated with an authorized user in step 1112, the method 1100 may continue to step 1113.

In step 1113, the user device may determine a position of the user device relative to the vehicle. For example, by comparing strengths of signals received by the device from a number of sensors around the vehicle sent to the user device, the user device may triangulate the position of the user device relative to the vehicle. In some embodiments, the relative position may comprise an indication of a particular door or other part of the vehicle.

In step 1115, the user device may activate a gesture recognition system. Activating the gesture recognition system may comprise activating a sensor of the user device such as an accelerometer and/or gyroscope. For example, the user device may execute a gesture recognition application. Accelerometer and/or gyroscopic sensor data may be collected by the user device. The user device may transmit such data to the vehicle over a wireless communications system such as Bluetooth or other LAN or WAN system.

In step 1118, the vehicle control system may receive gesture data from the user device. For example, raw sensor data sent from the user device to the vehicle may be received by sensors of the vehicle. The raw sensor data may be constantly or periodically received by the vehicle during the time in which the user device is within the threshold distance.

In step 1121, the vehicle control system may process the received gesture data with a convolutional neural network. Raw sensor data may be sampled as it is received by the vehicle. In some embodiments, time segments of a particular duration may be sampled and used as inputs into a neural network. Time segments may be, for example, one second windows of raw data. The raw sensor data may be pre-processed using one or more filters. The sensor data, raw or processed, may be analyzed using a multi-layer neural network such as a convolutional neural network. The network model may be created and trained by a network server and transmitted to the vehicle. In some embodiments, real-world data may be transmitted to the network server and used to update the model. Models may be customized for a particular vehicle, a particular user, or a group of users.

In step 1124, the vehicle control system may determine whether the received gesture data is associated with a verified gesture type. A number of models may be used to compare the received sensor data with a number of different types of gestures and/or different users. For example, a single sample of gesture data may be used as an input into multiple convolutional neural networks, in which each tests the input to determine if the gesture data is associated with a particular gesture. Each particular gesture may be a different command and may take into consideration particularities between different users.

If the gesture data is determined not to be associated with a verified gesture type in step 1124, the method 1100 may return to step 1118 and wait for new gesture data to be received from a user device. If, on the other hand, the gesture data is determined to be associated with a verified gesture type in step 1124, the method 1100 may continue to step 1127.

In step 1127, the vehicle control system may activate one or more features of the vehicle based on the gesture type and based on the relative position of the user device. For example, if the gesture data is determined to be associated with a single-door-unlock gesture, the vehicle control system may unlock a door closest to the relative position other device as determined in step 1113. In step 1130, the method 1100 may end.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a method for controlling access to a vehicle, the method comprising: determining, by a processor of a user device, a signal strength for each of one or more sensors of the vehicle; determining, by the processor, based on the determined signal strength for each of the one or more sensors, a location of the user device relative to the vehicle; based on the determination of the location of the user device, enabling, by the processor, a gesture recognition system; collecting, by the processor, data from a sensor of the user device; and determining, by the processor, a type of gesture associated with the received data from the user device; and wherein, based on the determined type of gesture, one or more functions of the vehicle are activated.

Aspects of the above method include wherein the one or more functions comprise one or more of vehicle power, driving capabilities, air conditioning, and an entertainment system.

Aspects of the above method include wherein determining location comprises determining a proximity of the user device to the vehicle.

Aspects of the above method include wherein the proximity is determined based on a signal strength between the user device and two or more sensors mounted to the vehicle.

Aspects of the above method include wherein the method further comprises, prior to detecting the gesture, activating, by the processor, the sensor of the user device.

Aspects of the above method include wherein the method further comprises determining, by the processor, a most proximal door of the vehicle in relation to the user.

Aspects of the above method include wherein the one or more functions of the vehicle comprise an unlocking of the most proximal door.

Aspects of the above method include wherein determining the identity of the user comprises analyzing, by the processor, one or more of a bearing, velocity, and gait of the user.

Aspects of the above method include wherein the gesture is one or more of a knock on a device associated with the user and a movement of the device.

Aspects of the above method include wherein detecting the gesture comprises receiving, by the processor, raw accelerometer data from a device associated with the user.

Aspects of the above method include wherein detecting the gesture further comprises analyzing, by the processor, the raw accelerometer data with a convolutional neural network.

Embodiments include a vehicle control system comprising: a processor; and a computer-readable storage medium storing computer-readable instructions which, when executed by the processor to perform steps of: determining a location of a user; detecting a gesture made by the user; determining an identity of the user; comparing the identify to a database; and based on the comparison, enabling access to one or more features of a vehicle.

Aspects of the above vehicle control system include wherein the one or more features comprise one or more of vehicle power, driving capabilities, air conditioning, and an entertainment system.

Aspects of the above vehicle control system include wherein determining location comprises determining a proximity of the user to the vehicle.

Aspects of the above vehicle control system include wherein the proximity is determined based on a signal strength between a device of the user and two or more sensors mounted to the vehicle.

Aspects of the above vehicle control system include, prior to detecting the gesture, activating a gesture detection system.

Aspects of the above vehicle control system include determining a most proximal door in relation to the user.

Aspects of the above vehicle control system include, prior to detecting the gesture and after detecting the most proximal door, activating a gesture detection system associated with the most proximal door.

Aspects of the above vehicle control system include wherein determining the identity of the user comprises analyzing one or more of a bearing, velocity, and gait of the user.

Embodiments include a computer program product, comprising: a non-transitory computer-readable storage medium having computer-readable program code embodied therewith, the computer-readable program code configured when executed by a processor to: determine a location of a user; detect a gesture made by the user; determine an identity of the user; compare identify to database; and based on the comparison, enable access to one or more features of the vehicle.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. A method for controlling access to a vehicle, the method comprising:
determining, by a processor of a user device, a signal strength for each of one or more sensors of the vehicle;
determining, by the processor, based on the determined signal strength for each of the one or more sensors, a location of the user device relative to the vehicle;
based on the determination of the location of the user device, enabling, by the processor, a gesture recognition system;
receiving, by the processor, data from a sensor of the user device;
determining, by the processor, a type of gesture associated with the received data from the user device; and
wherein, based on the determined type of gesture, activating one or more functions of the vehicle.

2. The method of claim 1, wherein the one or more functions comprise one or more of vehicle power, driving capabilities, air conditioning, and an entertainment system.

3. The method of claim 1, wherein determining location comprises determining a proximity of the user device to the vehicle.

4. The method of claim 3, wherein the proximity is determined based on a signal strength between the user device and two or more sensors mounted to the vehicle.

5. The method of claim 1, further comprising, prior to detecting the gesture, activating, by the processor, the sensor of the user device.

6. The method of claim 1, further comprising determining, by the processor, a most proximal door of the vehicle in relation to the user.

7. The method of claim 6, wherein the one or more functions of the vehicle comprise an unlocking of the most proximal door.

8. The method of claim 1, wherein determining the identity of the user comprises analyzing, by the processor, one or more of a bearing, velocity, and gait of the user.

9. The method of claim 1, wherein the gesture is one or more of a knock on a device associated with the user and a movement of the device.

10. The method of claim 1, wherein detecting the gesture comprises receiving, by the processor, raw accelerometer data from a device associated with the user.

11. The method of claim 10, wherein detecting the gesture further comprises analyzing, by the processor, the raw accelerometer data with a convolutional neural network.

12. A vehicle control system comprising:
a processor; and
a computer-readable storage medium storing computer-readable instructions which, when executed cause the processor to:
determine a location of a user;
detect a gesture made by the user;
determine an identity of the user;
compare the determined user identity to a database; and
based on the comparison and detected user gesture, enable access to one or more features of a vehicle.

13. The vehicle control system of claim 12, wherein the one or more features comprise one or more of vehicle power, driving capabilities, air conditioning, and an entertainment system.

14. The vehicle control system of claim 12, wherein determining location comprises determining a proximity of the user to the vehicle.

15. The vehicle control system of claim 14, wherein the proximity is determined based on a signal strength between a device of the user and two or more sensors mounted to the vehicle.

16. The vehicle control system of claim 12, further comprising, prior to detecting the gesture, activating a gesture detection system based on the determined user location.

17. The vehicle control system of claim 12, further comprising determining a most proximal door in relation to the user.

18. The vehicle control system of claim 17, further comprising, prior to detecting the gesture and after detecting the most proximal door, activating a gesture detection system associated with the most proximal door.

19. The vehicle control system of claim 12, wherein determining the identity of the user comprises analyzing one or more of a bearing, velocity, and gait of the user.

20. A computer program product, comprising:
a non-transitory computer-readable storage medium having computer-readable program code embodied therewith, the computer-readable program code configured, when executed by a processor, to:
determine a location of a user;
detect a gesture made by the user, wherein a set of sensors used to detect the user gesture is based on the determined user location;
determine an identity of the user;
compare the determined user identity to a database; and
based on the comparison and the detected user gesture, enable access to one or more features of the vehicle.
